(19) United States
(12) Patent Application Publication
(10) Pub. No.: US 2021/0321688 A1
(43) Pub. Date: Oct. 21, 2021

(54) DISPOSABLE RESPIRATOR FIT TEST HOOD AND METHOD OF MANUFACTURING SAME

(71) Applicant: FLEXcon Company, Inc., Spencer, MA (US)

(72) Inventor: Michael Merwin, Ware, MA (US)

(73) Assignee: FLEXcon Company, Inc., Spencer, MA (US)

(21) Appl. No.: 17/198,962

(22) Filed: Mar. 11, 2021

Related U.S. Application Data
(60) Provisional application No. 63/012,324, filed on Apr. 20, 2020.
(60) Provisional application No. 63/011,722, filed on Apr. 17, 2020.

(51) Int. Cl. A41D 13/11; C09J 7/38; C09J 7/25

(52) U.S. Cl. CPC A41D 13/1153; A41D 13/1176; A41D 13/1184; A41D 27/12; C09J 7/255; A41D 2200/20; C09J 7/385

(57) ABSTRACT

A single use disposable respirator fit test hood includes front and rear panels joined together along a left and right side edges, and a top edge with an adhesive, particularly a Pressure Sensitive Adhesive. The front panel is provided with an aperture through which test substances are introduced into interior cavity defined by the front and back panels. The test subject inserts their head through an opening defined by the bottom edges of the front and rear panels. During fabrication, shoulder pieces are cut off the front and rear panels to give the bottom edges a generally truncated V-shape. A portion of each shaped bottom edge rests on the test subject's shoulders. The hood is able to remain upright because of the thickness of the film used for the front and rear panels and the presence of the strips of pressure sensitive adhesive.

### CROSS-REFERENCE TO RELATED APPLICATIONS

This application claims the benefit of U.S. Provisional Patent Application Ser. No. 63/012,324 filed Apr. 20, 2020. This application also claims the benefit of U.S. Provisional Patent Application Ser. No. 63/011,722 filed Apr. 17, 2020. The entire disclosures of these two provisional patent applications are incorporated herein by reference.

### TECHNICAL FIELD

This disclosure is generally related to personal protective equipment. More particularly, this disclosure is directed to respirators. Specifically, the disclosure relates to a single use, disposable hood for fit testing respirators.

### BACKGROUND

### Background Information

Respirators are pieces of personal protective equipment that help to protect a person from inhaling infectious or hazardous substances that are in the person's immediate environment. These hazardous substances may be in the form of aerosolized liquids and particulate materials, and body fluids. Medical personnel, for example, may wear respirators when treating patients with infectious diseases, such as the current COVID-19 viral infection. Respirators are also worn by medical and dental professionals when performing some surgeries. People working in other professions may also need to wear respirators when performing their jobs. For example, people working in some industrial or chemical plants may be exposed to hazardous particulates and chemicals that may cause harm if inhaled. People who handle hazardous waste removal, such as the removal of asbestos, also need to wear respirators to protect themselves.

Most respirators are in the form of a mask that is worn on the lower portion of the face, covering the person's nose and mouth. The mask has an upper end that passes over the bridge of the nose and across the cheeks, and a lower portion that is seated under the chin. Straps extend from the sides of the mask and typically pass around the back of the head. The materials used to fabricate the mask help filter particulates and fluids and prevent them from being inhaled. A sealing material is usually applied to the interior of the mask adjacent the outer edges thereof so that a good seal may be obtained between the mask and the person's skin.

Respirators are only as good as how they fit on a person's face. If there is a good fit, i.e., a tight seal around the edges of the respirator and the person's skin, then all the air that the person breathes in, whether through the nose or mouth, will be forced to flow through the filtering materials of the respirator. In other instances, there may be poor contact between the edges of the respirator and the person's skin. Then, when the person breathes in, through either their nose or mouth, some of the air breathed in may flow between the edges of the mask and the person's skin. That air will not flow through the filtering materials of the respirator. As a consequence, the person wearing the respirator may be exposed to the hazardous or infectious substances in their environment and thereby come to harm. In other instances, there may be a flaw in the respirator itself, in which case the test subject (i.e., the person wearing the fit test hood) will taste the test substance that has been introduced into the hood.

It is therefore vital for people who have to wear a respirator in the performance of their work and for the organizations who employ such people to know whether or not a particular respirator fits a person properly and will therefore aid in protecting them in their hazardous environment. In the United States, OSHA (Occupational Safety and Health Administration) has mandated that every worker who will need to wear a tight-fitting respirator on the job has to be tested annually to ensure that the respirator they are to wear fits them properly. A qualitative test, known as a “fit test” is therefore undertaken by a large number of organizations each year. The specific procedure for the fit test is regulated by OSHA.

The fit test involves two main stages. In the first stage, the worker undergoes a sensitivity test when they are not wearing a respirator. In the second stage, the worker undergoes a fit test when they are wearing a respirator. The equipment for performing a fit test involves a fit test hood, a sweet test substance, a bitter test substance, and an apparatus for delivering the sweet test substance or bitter test substance into the hood. In the first stage, the worker places the fit test hood over their head and rests the lower edge of the hood on their shoulders. In some instances the hood is first engaged with a collar that will rest on the person's shoulders. The front of the fit test hood has a small aperture created therein. The tester will select which of the sweet and bitter substances to use and will spray a small quantity of the selected substance through the small aperture and into the space surrounding the person's head. The person undergoing the test keeps their mouth open and breathes only through their mouth. They are advised to let the tester know if they can taste the selected substance. A preset number of sprays of the selected substance in a preset period of time are undertaken and a score is assigned based on when the person indicates they taste the substance. The fit test hood will then be removed and the person is give a period of time to recover. If the person being tested cannot taste the selected substance in the preset period of time, after the recovery period, the first stage test will be repeated with the other of the sweet and bitter substances.

After the recovery period of about fifteen minutes, the second stage of the fit test is undertaken. The person being tested will put on their respirator, seal it as they have been previously taught, and place the fit test hood back over their head. The tester will then spray the substance the person previously tasted into the fit test hood in the same manner as before. This time however, they will use the score from the sensitivity test to guide when and how much of the selected substance to spray into the fit test hood. Additional sprays will be given at selected time intervals. The person being tested will be asked to signal if they can taste the selected substance. The tester will also walk the person being tested through a number of activities while wearing the fit test hood over their respirator. For example, the person being tested will be asked to take several deep breaths, turn their head to the left and right, look up and look down, bend over, and read a paragraph of text to the tester. The tester will periodically administer more of the selected substance through the aperture. If, at the end of the test period, the person being tested has not tasted the selected substance, then that particular type of respirator is deemed suitable for them to wear while they perform their job. If, on the other hand, they do taste the selected substance in the second stage of testing, then they will be asked to remove the fit test hood, remove the respirator, wait a particular amount of time, and then repeat the second stage of the test. If they still taste the selected substance in the second round of testing, then that particular respirator will be deemed unsuitable for them and another type of respirator will be tested on them using the above-described procedure.

One of the biggest issues with this type of testing is that all workers who require tight-fitting respirators at a particular facility have to be tested annually. For a very large hospital, for example, this may mean that hundreds, if not thousands, of their employees have to be tested. The hospital (or other facility) has to purchase quantities of fit test hoods to undertake this testing along with kits of the authorized sweet and bitter testing substances. The fit test hoods are reusable and have to be adequately wiped down and cleaned of all testing substances between fit testing of different employees. These fit test hoods tend to be quite expensive and for large organizations, in particular, this annual procedure can be an expensive, time consuming undertaking.

### SUMMARY

There is therefore a need in the art for a fit test hood that can be quickly and inexpensively fabricated. The fit test hood that is the subject of the present disclosure is a relatively inexpensive, single use, disposable fit test hood that includes front and rear panels joined together along a left and right side edges, and a top edge by an adhesive, for example by strips of Pressure Sensitive Adhesive (PSA). Suitable PSAs which may be selected for this purpose include a number of adhesives sold by FLEXcon Company, Inc. of Spencer, Mass., USA, including but not limited to FLEXcon's permanent acrylic adhesives sold under the trade names V-344, V-23, and V29 adhesives. Adhesives which are heat-activated including but not limited to FLEXcon's TC-160, TC-390, and TC-346, are also suitable for use in the disclosed application. In addition, reactive adhesives, i.e., adhesives that undergo a “cure” by which the bonding strength increases, are also suitable for use in the disclosed application. Such reactive adhesives include but are not limited to FLEXcon's V-45 adhesive. Additionally, ultra-violet curable adhesives are also suitable for use in the disclosed application, including but not limited to FLEXcon's V-464. The aforementioned adhesives can be applied via coating directly on the film or applied in the form of a transfer adhesive or a double-faced tape, or printed on the film in a desired pattern.

An additional possible method of bonding the films of the front and rear panels together includes ultrasonically welding the films to one another. This technique allows for an adhesive, such as one of the TC coatings described in the previous paragraph, to be selectively applied to a perimeter of the films such as to define the points of bond between the two films. (The TC 800 series of FLEXcon coatings are also suitable for use with this technique.) Alternatively, the adhesive may be applied over the entire film and then the films are bonded to one another at desired locations to form the fit test. This is accomplished by taking advantage of the localized heating ultrasonic welding affords to bond the films to one another. Bonding will only occur precisely where the ultrasonic device makes contact with the film. Another advantage of utilizing ultrasonic welding is that heat generated during this process can be limited in area. This reduces the risk that the entire film layers may be accidentally bonded to together and thereby failing to create a fit test hood that is able to be opened along a bottom edge for use.

In accordance with an aspect of the presently disclosed fit test hood, the front panel is provided with an aperture through which test substances are able to be introduced into interior cavity that is bounded and defined by the front and back panels. The test subject inserts their head through an opening defined by the bottom edges of the front and rear panels. During fabrication, shoulder pieces are cut off the front and rear panels to give the bottom edges a generally truncated V-shape. A portion of each shaped bottom edge rests on the test subject's shoulders. The hood is able to remain upright because of the thickness of the film used for the front and rear panels and the presence of the strips of pressure sensitive adhesive.

In one aspect, an exemplary embodiment of the present disclosure may provide a hood for use in performing a respirator fit test, said hood comprising a rear panel having a top edge, a bottom edge, a first side edge, and a second side edge; a front panel overlaying the rear panel, said front panel having a top edge, a bottom edge, a first side edge, and a second side edge; a pressure sensitive adhesive joining the rear panel and front panel together proximate the first side edges, the second side edges, and the top edges; wherein an inner surface of the rear panel and an inner surface of the front panel bound and define an interior cavity that is accessible through an opening defined by the bottom edges; and wherein the interior cavity is adapted to receive a person's head therein through the opening when the bottom edges rest on the person's shoulders.

In another aspect, an exemplary embodiment of the present disclosure may provide a method of performing a respirator fit test comprising providing a fit test hood comprising a front panel and a back panel secured together along three edge regions with an adhesive, and wherein a bottom edge of each of the front panel and rear panel is of a truncated V-shape; inserting a person's head through an opening defined by the bottom edges of the front panel and rear panel and into an interior cavity; introducing a test substance through an aperture defined in the front panel. In one embodiment, the method may further provide utilizing a Pressure Sensitive Adhesive. In one embodiment, the method may further comprise forming a truncated V-shape in the bottom edge of each of the front panel and rear panel; forming an apex at a lower end of a right side edge and a left side edge of the fit test hood; wherein each apex is located where the truncated V-shape of the front panel intersects the truncated V-shape of the rear panel; lowering the test hood onto the person's shoulders such that the apex on the right side edge rests on the person's right shoulder and the apex on the left side edge rests on the person's left shoulder.

In another aspect, and exemplary embodiment of the present disclosure may provide a method of manufacturing a fit test hood comprising direct coating a Pressure Sensitive Adhesive (PSA) in zones along a length of polymeric material; creating a tube from the polymeric material; cutting the tube into tube sections of a desired width and length; sealing a top edge of each tube section, wherein each tube section includes a front panel and a rear panel joined along three edges by the PSA. In one embodiment, the method may further comprise forming an aperture in the front panel, wherein the aperture is in fluid communication with an interior cavity defined by the front panel and rear panel. In one embodiment, the method may further comprise die-cutting shoulder pieces off a bottom edge of the front panel and the rear panel of each section.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a front elevation view of a person wearing a fit test hood in accordance with the present disclosure;

FIG. 2A is a side elevation view of the person wearing the fit test hood as shown in FIG. 1;

FIG. 2B is a side elevation view of the person wearing the fit test hood as shown in FIG. 1;

FIG. 3 is a front elevation view of the front sheet prior to assembly of the fit test hood;

FIG. 4 is a front elevation view of the back sheet prior to assembly of the fit test hood;

FIG. 5 is a front elevation view of the fit test hood during assembly showing the removal of triangular sections of the front and back sheets;

FIG. 6 is a cross-section of the top end of the fit test hood taken along line 6-6 of FIG. 1;

FIG. 6A is a cross-section of the top end of a second embodiment of the fit test hood similar to FIG. 6;

FIG. 6B is a cross-section of the top end of a third embodiment of the fit test hood similar to FIG. 6;

FIG. 6C is a cross-section of the top end of a fourth embodiment of the fit test hood similar to FIG. 6;

FIG. 7 is a flowchart showing a method of manufacturing the fit test hood of FIG. 1.

Similar numbers refer to similar parts throughout the drawings.

### DETAILED DESCRIPTION

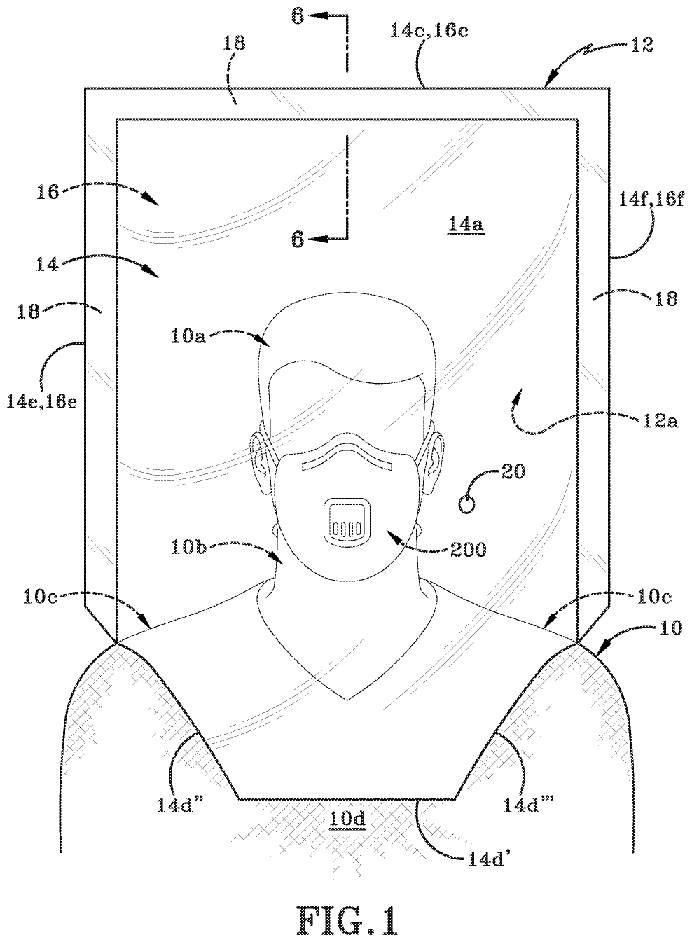

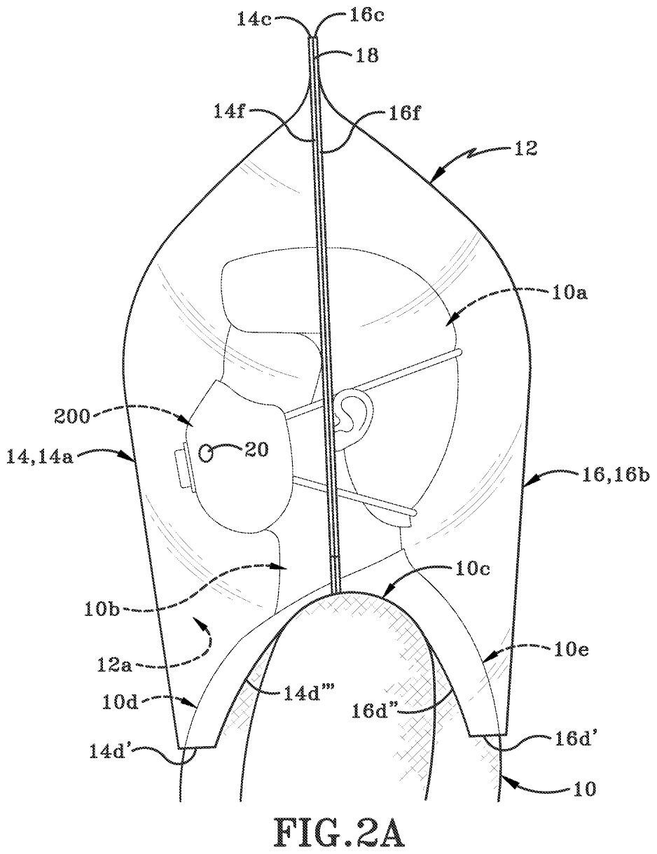

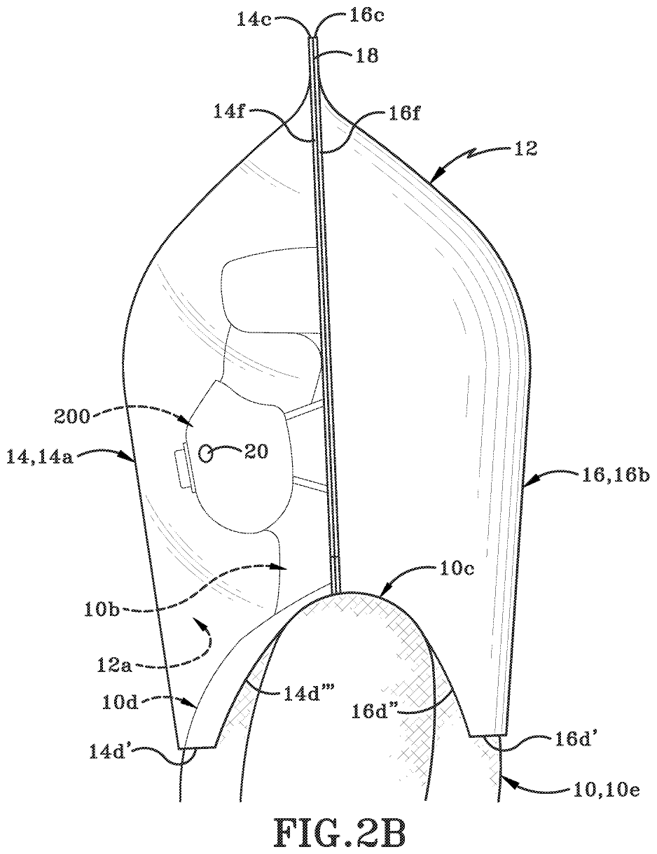

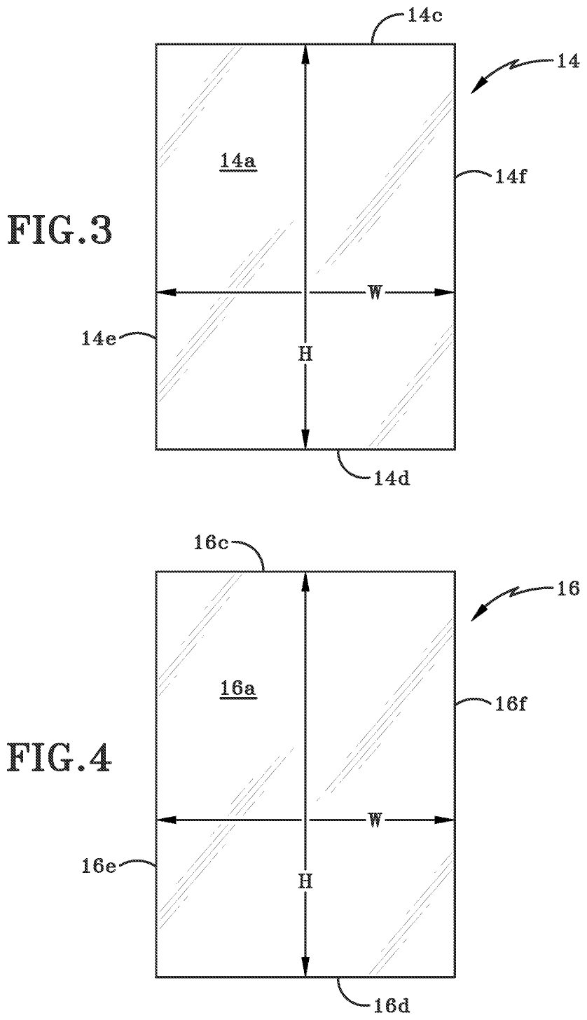

FIGS. 1, 2A, and 2B show a person 10 wearing a fit test hood in accordance with the present disclosure. The fit test hood (hereafter “hood”) is generally indicated by the reference number 12. The hood 12 is shown as entirely covering the person's head 10a and neck 10b, and resting on the top of the person's shoulders 12c. Part of a front of the hood 12 extends for a distance downwardly along an upper portion of the person's chest 10d. Another part of the hood 12 extends for a similar distance downwardly along an upper portion of the person's back 10e (FIG. 2).

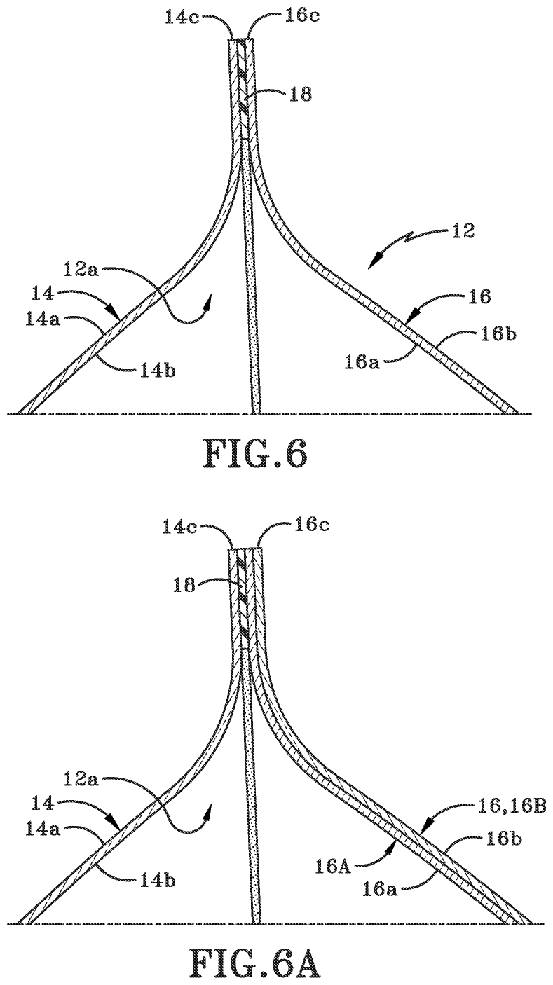

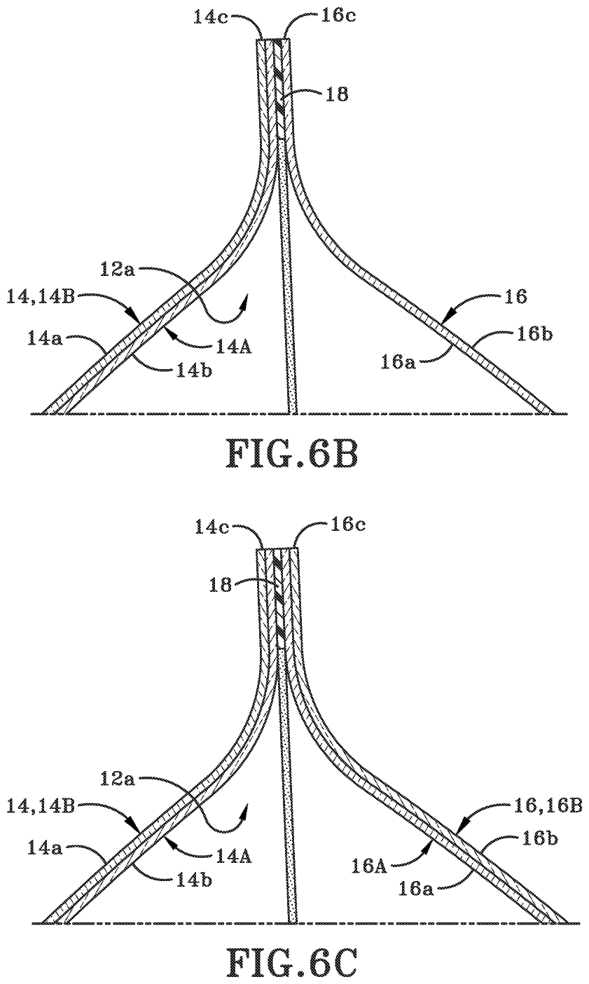

Hood 12 comprises a front panel 14 and a rear panel 16 that are joined together in a manner that will be described hereafter. Front panel 14 has a front surface 14a, a rear surface 14b (FIG. 6), a top edge 14c, a bottom edge 14d, a first side 14e, and a second side 14f. Front panel 14 is of a width “W” measured from first side 14e to second side 14f. Front surface 14a comprises an exterior surface of front panel 14 while rear surface 14b comprises an inner surface thereof. The width “W” is from about 18 inches wide up to about 30 inches wide. In one embodiment, the width “W” is about 24 inches wide. Front panel 14 is of a height “H” measured from top edge 14c to bottom edge 14d. Height “H” is from about 18 inches high up to about 28 inches high. In one embodiment, the height “H” is about 22 inches high.

Rear panel 16 has a front surface 16a, a rear surface 16b (FIG. 6), a top edge 16c, a bottom edge 16d, a first side 16e, and a second side 16f. Front surface 16a comprises an exterior surface of rear panel 16 while rear surface 16b comprises an inner surface thereof. Rear panel 16 is of substantially the same width “W” and height “H” as front panel 14.

Front panel 14 and rear panel 16 are both comprised of a suitable polymeric film that, when hood 12 is worn, enables hood 12 to stand upright, i.e., maintain its shape, on the person's shoulders 10c. One suitable polymeric film for fabricating hood is PET (polyethylene terephthalate). The thickness of the film used to fabricate front panel 14 and rear panel 16 may be from about 4 mm thick up to about 6 mm thick. The thickness of the film is measured from front surface 14a to rear surface 14b, or from front surface 16a to rear surface 16b. In one embodiment, the thickness of at least one of the front panel 14 and rear panel 16 is about 5 mm.

In accordance with an aspect of the disclosure and as illustrated in FIGS. 1, 2A and 2B, the film used to fabricate front panel 14 is clear or transparent. While the front panel 14 should be transparent, high clarity is not required. The front panel 14 needs to be sufficiently transparent or clear so as to allow the person 10 wearing the hood to read a paragraph of text through the front panel 14 during an actual fit test.

It will be understood that in other embodiments, only a part of the front panel is transparent. That transparent part of the front panel will be located so that the person 10 is able to see out of the transparent part. In other words, the transparent part will form a window in the front panel.

Rear panel 16 may be transparent, as shown in FIG. 2A. Alternatively, rear panel 16 may be opaque or translucent as shown in FIG. 2B. During fabrication of hood 12, front panel 14 and rear panel 16 are bonded together by an adhesive 18. In one embodiment, the adhesive 18 is a Pressure Sensitive Adhesive (PSA). Suitable PSAs which may be selected for use in the presently disclosed application are a number of adhesives sold by FLEXcon Company, Inc. of Spencer, Mass., USA, including but not limited to FLEXcon's permanent acrylic adhesives sold under the trade names V-344, V-23, and V29. Adhesives which are heat-activated (or thermally-activated) include but not limited to FLEXcon's TC-160, TC-390, and TC-346. These heat-activated PSAs are also suitable for use in the disclosed application. In addition, reactive adhesives, i.e., adhesives that undergo a “cure” by which the bonding strength increases, are also suitable for use in the disclosed application. Such reactive adhesives include but are not limited to FLEXcon's V-45 adhesive. Additionally, ultra-violet curable adhesives are also suitable for use in the disclosed application, including but not limited to FLEXcon's V-464. The aforementioned adhesives can be applied via coating directly on the film or applied in the form of a transfer adhesive or a double-faced tape, or printed on the film in a desired pattern.

An appropriate adhesive 18 will be selected for fabrication of hood 12. Prior to bonding the panels 14, 16 together, an aperture 20 is formed in front panel 14. The aperture 20 extends from front surface 14a through to rear surface 14b. In one embodiment, the aperture 20 is formed in a location that will be located between the person's left cheek and the left side edge of the hood 12. It will be understood that the aperture 20 may be located elsewhere on the front panel 14.

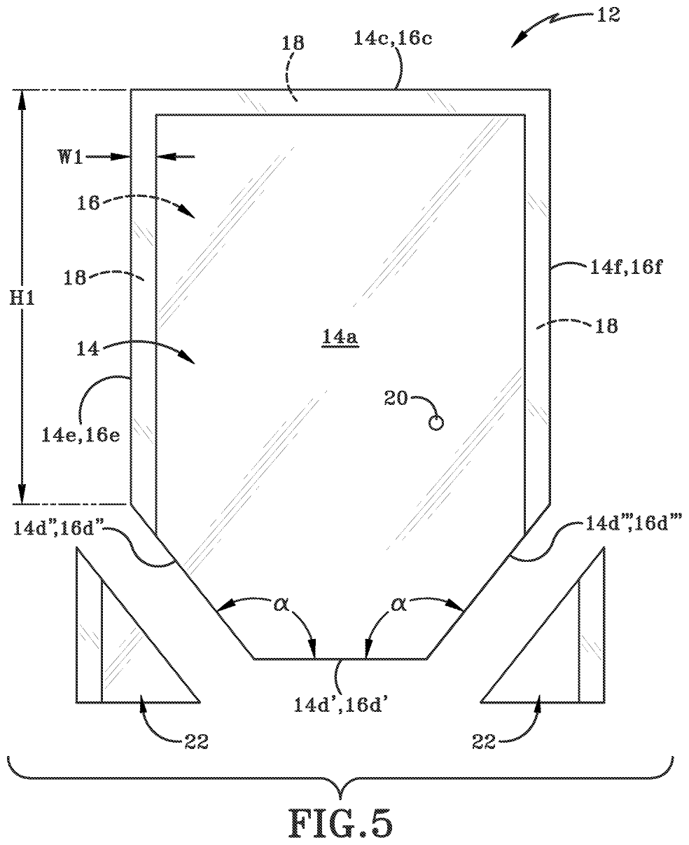

During assembly of hood 12, adhesive 18 is applied to front surface 16a of rear panel 16 and/or to rear surface 14b of front panel 14. In particular, the panels 14, 16 are laminated with adhesive 18 on three sides. For example, adhesive 18 is applied in a first strip adjacent first side 16e, in a second strip adjacent second side 16f, and in a third strip adjacent top edge 16c. Each of the first strip, the second strip, and the third strip is of a width “W1” (FIG. 5). Width “W1” is from about 0.5 inches up to about 3 inches. In one embodiment, the width “W1” is approximately two inches. The width “W1” is sufficient to aid the front panel 14 and rear panel 16 to stand upright when the hood 12 is worn.

The first, second, and third strips of the adhesive 18 may be applied substantially simultaneously or they may be applied in any order. Front panel 14 is positioned to overlay rear panel 16 in such a way that top edges 14c, 16c are aligned, first sides 14e, 16e are aligned, second sides 14f, 16f are aligned, and bottom edges 14d, 16d are aligned. The first strip of adhesive 18 is positioned adjacent first sides 14e, 16e, the second strip of adhesive is positioned adjacent second sides 14f, 16f, and the third strip of adhesive 18 is positioned adjacent top edges 14c, 16c. It will be understood that part or all of front panel 14 may be placed over rear panel 16 prior to applying some or all of the first, second, and third adhesive strips 18. Pressure is then applied to bond front panel 14 to rear panel 16.

Once front panel 14 and rear panel 16 are bonded together along three sides, substantially triangular pieces 22 (FIG. 5) are cut from the bonded front and rear panels 14, 16. In particular, the triangular pieces 22 are each a right-angled triangle that removes the lower left corner where first sides 14e, 16e meet bottom edges 14d, 16d and the lower right corner where second sides 14f, 16f meet bottom edges 14d, 16d. The removal of pieces 22 gives the bottom edge 14d of front panel 14 a truncated V-shape. In particular, the bottom edge of front panel comprises a central edge portion 14d′, a left edge portion 14d″, and a right edge portion 14d′″. Central edge portion 14d′ is part of the original bottom edge 14d. The left edge portion 14d″ extends between one end of central edge portion 14d′ and first side 14e. The right edge portion 14d′″ extends between an opposite end of central edge portion 14d′ and second side 14f. Left edge portion 14d″ and right edge portion 14d′″ are each oriented at an obtuse angle α relative to central edge portion 14d′. The angle α may be from about 120° up to about 150°. In one embodiment, the angle α is approximately 135°. It will be understood that the angle α may be any suitable angle that enables hood 12 to seat comfortably on the shoulders 10c of the person 10 wearing hood 12. It will be understood that the bottom edge of the hood 12, i.e., left edge portion 14d″, central portion 14d′, right edge portion 14d″, left edge portion 16d″, central portion 16d′, and right edge portion 14d′″ define an opening into the interior cavity 12a of hood 12. The opening is in fluid communication with interior cavity 12a.

It will be understood that the removal of pieces 22 will also cause bottom edge 16d of rear panel 16 to become identically shaped to bottom edge 14d. The bottom edge 16d of rear panel will therefore include a central edge portion 16d′ (FIG. 2A) that is identical to central edge portion 14d′, a left edge portion 16d″ (FIG. 2A) that is identical to right edge portion 14d′″, and a right edge portion (not shown) that is identical to left edge portion 14d″ of front panel 14. The lower region of rear panel 16 will therefore also have a truncated V-shape that is identical to the truncated V-shape of the lower region of front panel 14. It will also be understood that prior to the person putting on the hood 12, the region of the bottom edge of the hood 12 that will rest on the person's right shoulder will be of an inverted V-shape and will be comprised of the right edge portion (not shown) of rear panel 16 and the left edge portion 14d″ of front panel 14. The apex of this inverted V-shape will be where the right edge portion of the rear panel 16 and the left edge portion 14d″ intersect each other. Similarly, the region of the bottom edge of the hood that will rest upon the person's left shoulder will be of an inverted V-shape and will be comprised of the right edge portion 14d′″ of front panel 14 and the left edge portion 16″ of the rear panel 16. The apex of this inverted V-shape will be where the right edge portion 14d′″ and left edge portion 16″ intersect each other. As shown in FIG. 5, the height “H1” of the first side 14e from top edge 14c to the apex is shorter than the height “H” from the top edge 14c to the central edge portion 14d′. The inverted V-shaped regions are formed in such a way that an apex of that inverted V-shape may be located proximate a lowermost end of one of the seams formed where the left side edges 14f, 16f and the right side edges 14e, 16e join one another. These two inverted V-shaped cutout regions help to ensure that the hood 12 is seated properly on the person's shoulders.

It will be understood that in another embodiment, instead of cutting a right-angled triangular piece 22 from the bonded front and rear panels 14, 16, a generally-triangular piece that has a curved hypotenuse instead of a straight hypotenuse may be cut instead. In this instance, the lower regions of the front panel 14 and rear panel 16 will still have a generally truncated V-shape but the inverted V-shaped regions of the bottom edge of the hood 12 that rest on the person's shoulders 10c will be an inverted U-shape. The inverted U-shaped regions are formed in such a way that a central region of the inverted U-shape may be located proximate a lowermost end of one of the seams formed where the left side edges 14f, 16f and the right side edges 14e, 16e join one another. These two inverted U-shaped cutout regions also help to ensure that the hood 12 is seated properly on the person's shoulders.

FIG. 6 shows a cross-section through the top end of the hood 12. In particular, the figure shows a region proximate the top edge 14c of front panel 14 bonded to a region proximate the top edge 16c of rear panel 14 by the third strip of adhesive 18. FIG. 6A shows an alternative construction (a second embodiment) of the fit test hood where the rear panel is fabricated from two individual layers 16A, 16B that are bonded together. The laminated rear panel has a front surface 16a that bounds and defines the interior cavity 12a of the hood 12, and a rear surface 16b that forms part of the exterior surface of the hood 12. FIG. 6B shows a further alternative construction (a third embodiment) of the fit test hood where the front panel is fabricated from two individual layers 14A, 14B that are laminated together. The laminated front panel 14 has a front surface 14a that forms part of the exterior surface of the hood. The laminated front panel 14 also has a rear surface that bounds and defines a portion of the cavity 12a. FIG. 6C shows a further alternative construction (a fourth embodiment) of the fit test hood where the front panel is fabricated from two layers 14A, 14B that are laminated together and two layers 16A, 16B that are laminated together. The laminated front layer has a rear surface 14b and the laminated rear layer has a front surface 16a, and together the surfaces 14b, 16a bound and define the interior cavity 12a.

It will be understood that more than two layers of film may be laminated together to form front panel 14 and/or rear panel 16. The various layers of film, such as 14A and 14B do not have to be identical in nature to each other but can have different thicknesses and different properties. Furthermore, the layers of film 16A, 16B do not have to be identical to each other or to the layers 14A, 14B. Whatever the construction of the front panel 14 and rear panel, the films used to fabricate hood 12 need to impart the desired combination of transparency, flexibility and sturdiness so that hood 12 is capable of standing sufficiently upright on the person's shoulders 10c to enable a fit test to be conducted.

An additional possible method of bonding the films used for the front and rear panels 14, 16 together includes ultrasonically welding the films to one another. This technique allows for an adhesive, such as one of the TC coatings described in paragraph [0035] herein, to be selectively applied to a perimeter of the films such as to define the points of bond between the films. Alternatively, the heat reactivated adhesive (TC coating) may be applied over the entire surface of the film and then localized heating afforded by ultrasonic welding is utilized to bond the films at desired locations so as to form the fit test hood. Bonding will only occur precisely where the ultrasonic device makes contact with the film. The TC 800 series of FLEXcon coatings are also suitable for use with this technique. Films other than PET are also able to be bonded together using ultrasonic welding. These other films include but are not limited to acrylics and various polyolefins.

An additional advantage of using ultrasonic welding to bond the films together is that heat generated during this process can be limited in area. This reduces the risk that the entire film layers may be accidentally be bonded to one another. If the entire film layers are accidentally bonded to one another, then the front and rear panels 14, 16 will not be able to be separated from one another along the bottom edge so that a person can insert their head into the fit test hood.

It will be understood that the fit test hood in accordance with the present disclosure may be formed precisely with heating processes other than ultrasonic welding but this may require more of a patterned coating of a heat activated adhesive to be applied to the films.

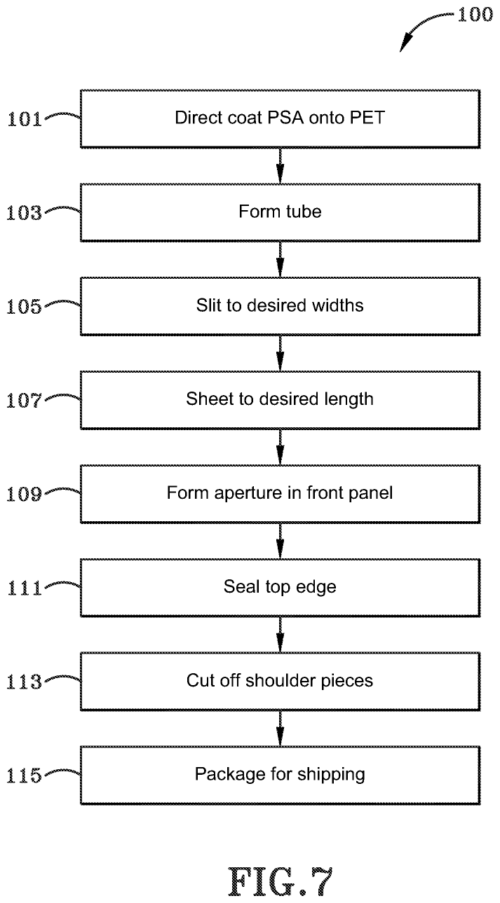

Referring now to FIG. 7, there is shown an exemplary method 100 of fabricating fit test hood 12. This exemplary method 100 relates to the production of a hood 12 where both the front panel 14 and rear panel 16 are produced utilizing transparent PET film.

The PET used for fit test hood 12 may be produced using providing two layers of PET film that will ultimately become the front panel 14 and rear panel 16 of a plurality of fit test hoods 12. As will be described hereafter, the two layers are bonded together with adhesive 18 for ease of fabrication. In one embodiment, each layer of polymeric film is about 5 mm thick. A first step 101 of the method 100 involves direct coating, i.e., printing, PSA 18 onto one or both of the layers of polymeric film. Zone coating allows the two layers of polymeric film to be joined together in the machine direction. The method further includes slitting the tube to desired widths 105, and sheeting to desired lengths 107, i.e., cutting the tube to desired lengths. In one example, the tube is slit to a width of 24 inches and to a length of 22 inches. These steps 105, 107 create tube sections that each comprise a front panel 14 and rear panel 16 joined together proximate their left and right side edges 14f, 16f, and 14e, 16e, respectively by strips of pressure sensitive adhesive 18. Where the left side edge 14f, 16f and right side edges 14e, 16e are joined to one another a seam is formed. The seams in the left side of the hood 12 and the right side of the hood 12 are opposed to one another. When the tube is cut into these tube sections or after the cutting, a two-sided PSA tape or transfer film is introduced between the top edges 14c, 16c in order to allow that region of the tube section to be sealed together. In another step 109, which may occur at any time in the process before or after a sealing step 111 (see below), an aperture 20 is formed in front panel 14 of each tube section. The aperture 20 may be formed by hole punching the PET film. Preferably, the aperture is circular in shape but in other embodiments, other shaped apertures may be formed. For example, the aperture may be square instead of circular or may be formed in as an X-shaped slit. The rear panel 16 of each section is free of apertures that are in fluid communication with the interior cavity 12a defined by the front and rear panels.

In step 111, the regions of the front and rear panels, adjacent top edges 14c, 16d, is sealed using the introduced third strip of PSA. The shoulder pieces 22 are then die-cut from the partially completed hood 113 to produce the end product, i.e. the fit test hood 12 shown in FIGS. 5 and 1. A plurality of fit test hoods 12 may then be packaged 115 for shipping. For example, a plurality of fit test hoods 12 may be stacked one on top of the other, placed in a box, and then ultimately shipped to a customer.

When a fit test is to be conducted the person being test will insert their head 10a through the opening defined by the bottom edges 14d, 16d of the front panel 14 and rear panel 16 and into the interior cavity 12a. The person will then lower the hood 12 until part of the left edge portion 14d″ and right edge portion 16d′″ rests on their right shoulder 10c; and part of the right edge portion 14d′″ and left edge portion 16d″ rests on their right shoulder 10c. The person 10 is then ready to undergo the first stage of the fit test as described in the background section herein, and which is well known in the art. During the first stage of the fit test, the test substances will be introduced into the interior cavity 12a of hood 12 through the aperture 20 in front panel 14 in the form of a mist. After the first stage of the fit test has been completed, the person 10 will take off the hood 12 , will wait the allotted time period, put on their respirator 200 (FIG. 1), insert their head 10a into the hood cavity 12a again, and then the second stage of the fit test will then proceed. Again, the test substances will be introduced into the cavity 12a through aperture 20. When the second stage is completed successfully, the hood 12 will be removed and disposed of as described below.

It will be understood that fit test hood 12 is contemplated to be fabricated from materials that make it suitable for a single, one time use. After use, fit test hood will be disposed of. In some instances this may involve recycling of the fit test hood, if the materials used in the construction of the same are suitable for recycling. Recycling may be possible because the hood 12 is not used in the actual treatment of patients who may be medically compromised, nor is the hood 12 used in hazardous environments. In other instances, the fit test hood will be thrown in the landfill.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “element A and/or element B”, when used in conjunction with open-ended language such as “comprising” can refer, in one embodiment, to element A only (optionally including elements other than element B); in another embodiment, to element B only (optionally including elements other than element A); in yet another embodiment, to both element A and element B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clarity, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A hood for use in performing a respirator fit test, said hood comprising:
a rear panel having a top edge, a bottom edge, a first side edge, and a second side edge;
a front panel overlaying the rear panel, said front panel having a top edge, a bottom edge, a first side edge, and a second side edge;
an adhesive joining the rear panel and front panel together proximate the first side edges, the second side edges, and the top edges;
wherein an inner surface of the rear panel and an inner surface of the front panel bound and define an interior cavity that is accessible through an opening defined by the bottom edges; and
wherein the interior cavity is adapted to receive a person's head therein through the opening when the bottom edges rest upon the person's shoulders.

2. The hood according to claim 1, wherein the adhesive is a Pressure Sensitive Adhesive (PSA).

3. The hood according to claim 2, wherein the PSA is one of a permanent acrylic adhesive, a heat-activated adhesive, a reactive adhesive, and an ultra-violet curable adhesive.

4. The hood according to claim 2, wherein the PSA is one of applied via coating directly onto a film, in a form of a transfer adhesive, in a form of a double-faced tape, and printed on the film in a desired pattern.

5. The hood according to claim 1, wherein at least a part of the front panel is transparent.

6. The hood according to claim 1, further comprising an aperture defined in the front panel, said aperture extending between an exterior surface and the inner surface of the front panel, and wherein the aperture is in fluid communication with the interior cavity.

7. The hood according to claim 1, wherein the bottom edges of the front panel and the rear panel are of a truncated V-shape.

8. The hood according to claim 1, wherein the front panel and the rear panel, together, form two opposed seams where the rear panel and the front panel are joined to one another along the first side edges and the second side edges.

9. The hood according to claim 8, further comprising a cutout formed by the bottom edges of the rear panel and the front panel proximate each of the two opposed seams, and wherein each cutout is adapted to receive one of the person's shoulders therein.

10. The hood according to claim 9, wherein the cutout is one of an inverted V-shape and an inverted U-shape.

11. A method of performing a respirator fit test comprising:
providing a fit test hood comprising a front panel and a back panel secured together along three edge regions with an adhesive, and wherein a bottom edge of each of the front panel and rear panel is of a truncated V-shape;
inserting a person's head through an opening defined by the bottom edges of the front panel and rear panel and into an interior cavity;
introducing a test substance through an aperture defined in the front panel.

12. The method according to claim 11, further comprising utilizing a Pressure Sensitive Adhesive (PSA).

13. The method according to claim 12, further comprising selecting one of a permanent acrylic adhesive, a heat-activated adhesive, a reactive adhesive, and an ultra-violet curable adhesive as the PSA.

14. The hood according to claim 13, further comprising applying the PSA by one of coating the selected adhesive directly onto a film, applying the selected adhesive in a form of a transfer adhesive, applying the selected adhesive in a form of a double-faced tape, and printing the selected adhesive on the film in a desired pattern.

15. The hood according to claim 11, wherein the front panel and back panel are secured to one another using ultrasonic welding.

16. The method according to claim 11, further comprising:
forming a truncated V-shape in the bottom edge of each of the front panel and rear panel.

17. The method according to claim 16, further comprising:
forming an apex at a lower end of a right side edge and a left side edge of the fit test hood; wherein each apex is located where the truncated V-shape of the front panel intersects the truncated V-shape of the rear panel.

18. The method according to claim 17, further comprising:
lowering the test hood onto the person's shoulders such that the apex on the right side edge rests on the person's right shoulder and the apex on the left side edge rests on the person's left shoulder.

19. A method of manufacturing a fit test hood comprising:
direct coating a Pressure Sensitive Adhesive (PSA) in zones along a length of polymeric material;
creating a tube from the polymeric material;
cutting the tube into tube sections of a desired width and length;
sealing a top edge of each tube section, wherein each tube section includes a front panel and a rear panel joined along three edges by the PSA; and
forming an aperture in the front panel, wherein the aperture is in fluid communication with an interior cavity defined by the front panel and rear panel.

20. The method according to claim 19, comprising creating the tube from a clear or transparent polymeric film.

21. The method according to claim 19, further comprising:
die-cutting shoulder pieces off a bottom edge of the front panel and the rear panel of each section.

22. The method according to claim 19, wherein the sealing of the top edge of each tube section includes ultrasonically welding the top edge of each tube section.
